(19) United States
(12) Patent Application Publication
(10) Pub. No.: US 2007/0007378 A1
(43) Pub. Date: Jan. 11, 2007

(54) Bait reel

(75) Inventor: Kwang Ho Hyun, Buchun-City (KR)

Correspondence Address: ST. ONGE STEWARD JOHNSTON & REENS, LLC, 986 BEDFORD STREET, STAMFORD, CT, 06905-5619, US

(73) Assignee: Doyo Engineering Co., Ltd.

(21) Appl. No.: 11/282,813

(22) Filed: Nov. 18, 2005

(30) Foreign Application Priority Data
Jun. 23, 2005 (KR) 20-2005-0018168

(51) Int. Cl. A01K 89/015

(52) U.S. Cl. 242/310

(57) ABSTRACT

A bait reel is provided. The bait reel has a reel frame for supporting a spool, and a side cover installed at one side of the reel frame and protecting a drive gear for transmitting a rotation force to the spool and a plurality of built-in components. In the bait reel, the side cover has an injection hole perforated at its exterior surface and supplying a lubricant to the drive gear and the built-in components, and a cover body is detachably fitted into the injection hole.

### CROSS-REFERENCE TO RELATED APPLICATIONS

This application claims priority of Korean Patent Application No. 20-2005-0018168 filed on Jun. 23, 2005.

### FIELD OF THE INVENTION

The present invention relates to a bait reel, and more particularly, to a bait reel for simply and conveniently injecting a lubricant to a drive gear and a plurality of built-in components provided inside a side cover being a constituent component of the bait reel, and improving a rotation durability and a hoist power.

### DESCRIPTION OF RELATED ART

As well known in the art, a bait reel for fishing includes a reel frame; a spool rotatably mounted at the reel frame and winding a fishing line; a handle installed at one side of the reel frame and rotationally driving the spool; and a side cover installed between the handle and the reel frame.

The side cover protects the drive gear, which is a power transmission means for transmitting the rotation force of the handle to the spool, and a plurality of built-in components connected to the drive gear.

In general, the side cover is mounted such that it can be engaged and disengaged from the reel frame. This is to perform maintenance and management by periodically injecting the lubricant to the drive gear and the built-in components built in the side cover, in order to smoothly transmit the rotation force to the spool.

However, in the conventional bait reel, a work of disengaging the side cover should be necessarily preceded when the lubricant is injected, and together with a troublesomeness of an injection work, there is not only a concern of loss of components in a process of disengagement (disassembly), but also is a drawback of losing an original function of the bait reel due to an erroneous reassembly.

### SUMMARY OF THE INVENTION

Accordingly, the present invention is directed to a bait reel that substantially overcomes one or more of the limitations and disadvantages of the conventional art.

One object of the present invention is to provide a bait reel in which an injection hole is provided by perforating an exterior surface of a side cover, to be opened and closed with a cover body in an airtight fashion, thereby simply and conveniently supplying a lubricant to a drive gear and built-in components through the injection hole according to need.

Another object of the present invention is to provide a bait reel in which a cover body is screwed and fixed using a screw horizontally passing through a reel frame and a side cover, thereby enabling its smooth disengagement/engagement.

A further another object of the present invention is to provide a bait reel for minimizing a gap between a reel frame and a side cover using a screw, and increasing an engagement strength, thereby improving a rotation durability and a hoist power.

A still another object of the present invention is to provide a bait reel in which a cover body is constructed not to protrude from an exterior surface of a side cover, thereby preventing the bait reel from being deteriorated in appearance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a bait reel having a reel frame for supporting a spool, and a side cover installed at one side of the reel frame and protecting a drive gear for transmitting a rotation force to the spool and a plurality of built-in components, wherein the side cover has an injection hole perforated at its exterior surface and supplying a lubricant to the drive gear and the built-in components, and wherein a cover body is detachably fitted into the injection hole.

The cover body may be screwed to a screw horizontally passing through the reel frame and the side cover.

It is to be understood that both the foregoing summary and the following detailed description of the present invention are merely exemplary and intended for explanatory purposes only.

### BRIEF DESCRIPTION OF DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a side view illustrating a bait reel according to a preferred embodiment of the present invention;

FIG. 2 is a plan view illustrating the bait reel of FIG. 2; and

FIG. 3 illustrates a state of injecting a lubricant inside a side cover of a bait reel according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

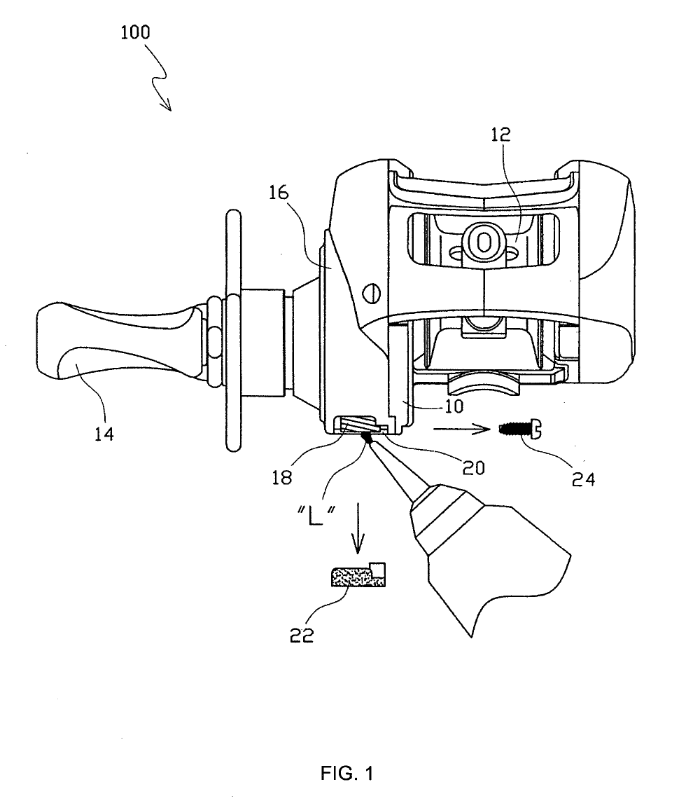

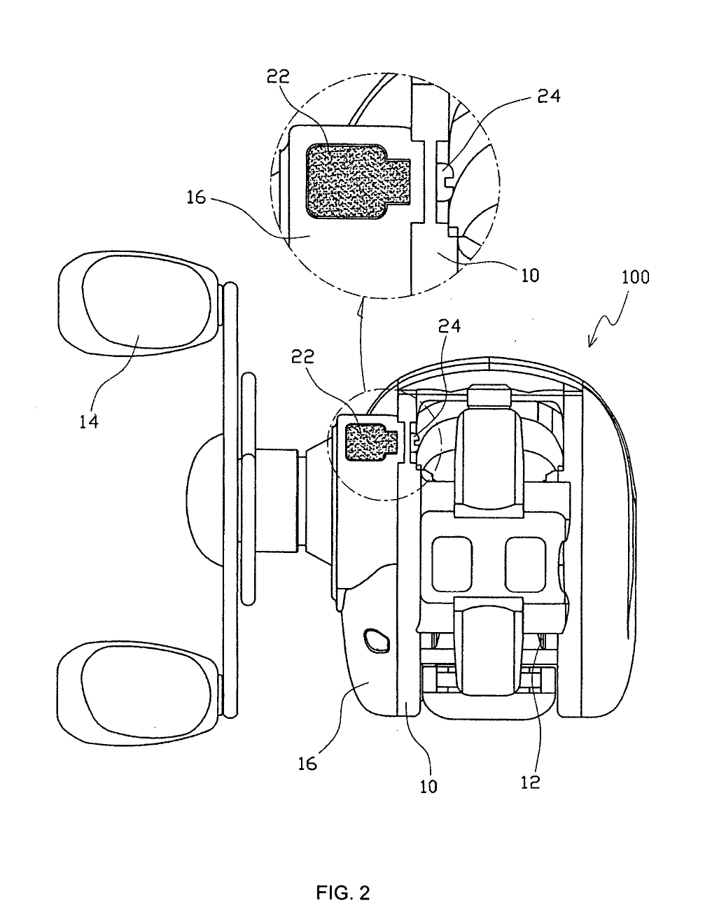

FIGS. 1 to 3 illustrate components of a bait reel according to the present invention.

As shown in FIGS. 1 to 3, the bait reel 100 includes a reel frame 10 corresponding to a main body; a spool 12 rotatably mounted at the reel frame 10 and winding a fishing line; a handle 14 installed at one side of the reel frame 10, and rotationally driving the spool 12; and a side cover 16 for protecting a drive gear 18 being a power transmission means and a plurality of built-in components (not shown). The above-constructed bait reel 100 transmits a rotation operation of the handle 14 to a spool shaft (not shown) through the drive gear 18 and the plurality of built-in components, and forwardly or reversely rotates the spool 12 to wind or unwind the fishing line. Detailed construction and operation of the bait reel 100 have been already known in the art and therefore, their detailed descriptions will be omitted.

Among the components of the bait reel 100, the side cover 16 has an injection hole 20 perforated on its exterior surface and opened and closed using a separate cover body 22 in an airtight fashion. The injection hole 20 is to facilitate to supply a lubricant (L) to the drive gear 18 and the plurality of built-in components provided inside the side cover 16 even though the side cover 16 is not disengaged from the reel frame 10.

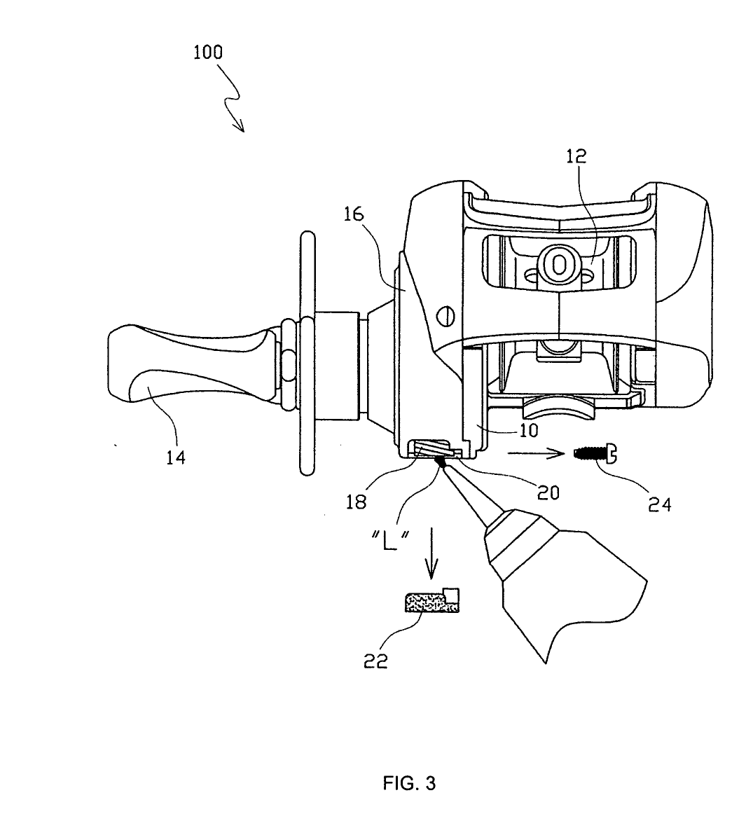

In other words, the drive gear 18 and the built-in components should be maintained and managed by periodically receiving the lubricant, in order to smoothly transmit a rotation force to the spool 12. In this case, even though the side cover 16 is not disengaged, as shown in FIG. 3, the injection hole 20 is opened by drawing-out a screw 24 (later described), unlocking the cover body 22, and detaching the cover body 22, and the lubricant (L) is injected into the opened injection hole 20, thereby simply and conveniently supplying the lubricant (L) to the drive gear 18 and the built-in components. The cover body 22 is fitted into the injection hole 20 not to protrude from an exterior surface of the side cover 16 and preferably, is positioned to be on the same line as a surface of the side cover 16. This is to supply the lubricant (L) without deteriorating the bait reel 100 in appearance.

The cover body 22 is screwed to the screw 24 horizontally passing through the reel frame 10 and the side cover 16, thereby being fixed into the injection hole 20. Accordingly, the cover body 22 can be simply and conveniently attached to and detached from the injection hole 20, thereby opening and closing the injection hole 20, depending on screwing and unscrewing operations of the screw 24. The screw 24 has both a function of fixing the cover body 22, and a function of increasing a strength of engagement between the reel frame 10 and the side cover 16 to prevent generation of a gap between the reel frame 10 and the side cover 16. Accordingly, foreign materials can be prevented from being introduced into the gap, and a rotation durability and a hoist power can be improved owing to increase of the engagement strength.

The operation of the bait reel 100 will be described below.

As shown in FIG. 3, when the lubricant (L) is supplied to the drive gear 18 and the plurality of built-in components provided inside of the side cover 16, the screw 24 horizontally passing through the reel frame 10 and the side cover 16 is first unscrewed and disengaged and then, the cover body 22 is unlocked from the screw 24 and simply and conveniently detached from the injection hole 20, thereby opening the injection hole 20. Accordingly, even though the side cover 16 is not disengaged from the reel frame 10 as in a conventional art, the lubricant (L) can be supplied to the drive gear 18 and the built-in components through the opened injection hole 20.

As described above, the present invention accomplishes many effects as follows.

First, the present invention has an effect in that even though the side cover is not disengaged, the lubricant can be supplied to the drive gear and the built-in components through the injection hole provided by perforating the exterior surface of the side cover, thereby not only removing a concern of loss of components in a disengagement process but also solving a drawback of losing an original function of the bait reel due to an erroneous reassembly.

Second, the present invention has an effect in that the cover body for opening and closing the injection hole can be screwed and fixed using the screw horizontally passing through the reel frame and the side cover, thereby enabling its smooth disengagement/engagement.

Third, the present invention has an effect of minimizing the gap between the reel frame and the side cover using the screw, and increasing the engagement strength, thereby improving the rotation durability and the hoist power.

Fourth, the present invention has an effect in that the cover body is constructed not to protrude from the exterior surface of the side cover, thereby preventing the bait reel from being deteriorated in any appearance.

While the present invention has been described with reference to exemplary embodiments thereof, it will be apparent to those skilled in the art that various modifications can be made therein without departing from the spirit and scope of the invention as defined by the appended claims and their equivalents.

1. A bait reel having a reel frame for supporting a spool, and a side cover installed at one side of the reel frame and protecting a drive gear for transmitting a rotation force to the spool and a plurality of built-in components, wherein the side cover has an injection hole formed at its exterior surface for supplying a lubricant to the drive gear and the built-in components, and wherein a cover body is detachably fitted in the injection hole and screwed with a screw for assembly, the screw passing through the reel frame and the side cover in a direction parallel to an extending direction of the cover body such that the reel frame and the side cover are tightened together and a gap between the reel frame and the side cover is reduced by the screwed connection.

2. (canceled)

3. The bait reel according to claim 1, wherein the cover body is fitted in the injection hole with an exterior surface of the cover body flushing with an external surface of the side cover.
